(19) United States
(12) Patent Application Publication
(10) Pub. No.: US 2021/0211192 A1
(43) Pub. Date: Jul. 8, 2021

(54) OPTICAL SIGNAL REPEATER AND FAILURE DETERMINATION METHOD FOR OPTICAL SIGNAL REPEATER

(71) Applicant: Sumitomo Electric Industries, Ltd., Osaka-shi, Osaka (JP)

(72) Inventor: Tomoyuki FUNADA, Osaka-shi, Osaka (JP)

(73) Assignee: Sumitomo Electric Industries, Ltd., Osaka-shi, Osaka (JP)

(21) Appl. No.: 16/071,306

(22) PCT Filed: Oct. 3, 2016
(86) PCT No.: PCT/JP2016/079265

§ 371 Date: Jul. 19, 2018

(30) Foreign Application Priority Data
Feb. 23, 2016 (JP) 2016-031725

(51) Int. Cl. H04B 10/038; H04B 10/032; H04B 10/29; H04L 29/14

(52) U.S. Cl. CPC H04B 10/038; H04L 69/40; H04B 10/29; H04B 10/032

(57) ABSTRACT

An optical signal repeater includes: at least one first repeating unit configured to repeat an optical signal; at least one second repeating unit configured to be interchangeable with the first repeating unit; a branch portion configured to branch an optical signal and provide the branched optical signal to each of the first repeating unit and the second repeating unit; a failure determination unit configured to compare a signal output from the first repeating unit with a signal output from the second repeating unit, and determine presence or absence of failure in the first repeating unit; and a redundancy switching control unit configured to, if the failure determination unit determines the presence of failure in the first repeating unit, execute redundancy switching between the first repeating unit and the second repeating unit.

### TECHNICAL FIELD

The present invention relates to an optical signal repeater and a failure determination method for an optical signal repeater.

The present application claims a priority based on Japanese Patent Application No. 2016-031725 filed on Feb. 23, 2016, the entire content of which is incorporated herein by reference.

### BACKGROUND ART

Japanese Patent Laying-Open No. 2004-104177 (PTD 1) and Japanese Patent Laying-Open No. 2004-104182 (PTD 2) disclose a passive optical network (PON) system including a dual-redundant optical signal repeater. A failure in a transmission path of the PON is detected by an optical line terminal (OLT) or an optical signal repeater.

For example, Japanese Patent Laying-Open No. 2007-295507 (PTD 3) and Japanese Patent Laying-Open No. 2015-5862 (PTD 4) disclose a repeater that controls its operation in accordance with instructions from an OLT.

### CITATION LIST

### Patent Document

PTD 1: Japanese Patent Laying-Open No. 2004-104177
PTD 2: Japanese Patent Laying-Open No. 2004-104182
PTD 3: Japanese Patent Laying-Open No. 2007-295507
PTD 4: Japanese Patent Laying-Open No. 2015-5862

### SUMMARY OF INVENTION

An optical signal repeater according to one aspect of the present invention includes: at least one first repeating unit configured to repeat an optical signal; at least one second repeating unit configured to be interchangeable with the first repeating unit; a branch portion configured to branch an optical signal and provide the branched optical signal to each of the first repeating unit and the second repeating unit; a failure determination unit configured to compare a signal output from the first repeating unit with a signal output from the second repeating unit, and determine presence or absence of failure in the first repeating unit; and a redundancy switching control unit configured to, if the failure determination unit determines the presence of failure in the first repeating unit, execute redundancy switching between the first repeating unit and the second repeating unit.

A failure determination method for an optical signal repeater according to one aspect of the present invention is a failure determination method for an optical signal repeater configured to repeat an optical signal. The optical signal repeater includes a first repeating unit, a second repeating unit configured to be interchangeable with the first repeating unit, and a failure determination unit. The method includes: branching an optical signal and providing the branched optical signal to each of the first repeating unit and the second repeating unit; comparing, using the failure determination unit, a first signal output from the first repeating unit with a second signal output from the second repeating unit; and determining, using the failure determination unit, presence or absence of failure in the first repeating unit based on the result of the comparing of the first signal with the second signal.

### BRIEF DESCRIPTION OF DRAWINGS

FIG. 1 shows an example configuration of an optical communication system in a first embodiment of the present invention.

FIG. 2 is a block diagram showing a schematic configuration of an optical signal repeater in the first embodiment of the present invention.

FIG. 3 is a diagram for illustrating the determination of the presence or absence of failure in a repeating unit with the use of a downstream signal by an optical signal repeater in the first embodiment of the present invention.

FIG. 4 is a diagram for illustrating the determination of the presence or absence of failure in a repeating unit with the use of an upstream signal by an optical signal repeater in the first embodiment of the present invention.

FIG. 5 is a block diagram showing an example configuration of a repeating unit included in the optical signal repeater shown in FIG. 2.

FIG. 6 is a block diagram showing an example configuration of a failure determination unit included in the optical signal repeater shown in FIG. 2.

FIG. 7 is a flowchart illustrating the determination of the presence or absence of failure in a repeating unit and redundancy switching by an optical signal repeater in the first embodiment of the present invention.

FIG. 8 is a block diagram showing an optical communication system and an optical signal repeater in a second embodiment of the present invention.

FIG. 9 is a block diagram showing an example configuration of a repeating unit included in the optical signal repeater shown in FIG. 8.

FIG. 10 is a diagram for illustrating the determination of the presence or absence of failure of a repeating unit with the use of a downstream signal by an optical signal repeater in the second embodiment of the present invention.

FIG. 11 is a diagram for illustrating the determination of the presence or absence of failure in a repeating unit with the use of an upstream signal by an optical signal repeater in the second embodiment of the present invention.

FIG. 12 is a block diagram schematically showing an optical communication system and an optical signal repeater in a third embodiment of the present invention.

FIG. 13 is a block diagram showing a part of an optical communication system in the third embodiment of the present invention.

FIG. 14 is a diagram for illustrating the determination of the presence or absence of failure in a repeating unit with the use of a downstream signal by an optical signal repeater in the third embodiment of the present invention.

FIG. 15 is a diagram for illustrating the determination of the presence or absence of failure in a repeating unit with the use of an upstream signal by an optical signal repeater in the third embodiment of the present invention.

FIG. 16 is a block diagram showing an optical communication system and an optical signal repeater in a fourth embodiment of the present invention.

FIG. 17 is a diagram for illustrating the determination of the presence or absence of failure in a repeating unit with the use of a downstream signal by an optical signal repeater in the fourth embodiment of the present invention.

FIG. 18 is a diagram for illustrating the determination of the presence or absence of failure in a repeating unit with the use of an upstream signal by an optical signal repeater in the fourth embodiment of the present invention.

FIG. 19 is a block diagram showing an optical communication system and an optical signal repeater in a fifth embodiment of the present invention.

FIG. 20 is a diagram for illustrating the determination of the presence or absence of failure in a repeating unit with the use of a downstream signal by an optical signal repeater in the fifth embodiment of the present invention.

FIG. 21 is a diagram for illustrating the determination of the presence or absence of failure in a repeating unit with the use of an upstream signal by an optical signal repeater in the fifth embodiment of the present invention.

FIG. 22 is a block diagram showing a part of an optical communication system in a sixth embodiment of the present invention.

FIG. 23 is a block diagram showing an optical communication system and an optical signal repeater in a seventh embodiment of the present invention.

FIG. 24 is a block diagram showing a part of an optical communication system in the seventh embodiment of the present invention.

FIG. 25 is a diagram for illustrating the determination of the presence or absence of failure in a repeating unit with the use of a downstream signal by an optical signal repeater in the seventh embodiment of the present invention.

FIG. 26 is a diagram for illustrating the determination of the presence or absence of failure in a repeating unit with the use of an upstream signal by an optical signal repeater in the seventh embodiment of the present invention.

### EMBODIMENTS TO CARRY OUT INVENTION

### Problem to be Solved by the Present Disclosure

A conventional optical signal repeater disclosed in the documents listed above cannot autonomously determine the presence or absence of its own failure. Accordingly, the presence or absence of failure of the optical signal repeater has to be determined by a managing apparatus arranged at a master station. For example, the operating status of an optical signal repeater arranged at a slave station (remote station) is transmitted from the repeater to a managing apparatus at a master station. In one example, the optical signal repeater transmits information to an OLT using a connection signal with the OLT, and the managing apparatus obtains the information through the OLT. Alternatively, the optical signal repeater transmits information directly to the managing apparatus at the master station using another line. Further, in the case of an optical signal repeater having a redundant configuration, the managing apparatus not only needs to determine the presence or absence of failure in the optical signal repeater, but also needs to control the redundancy switching within the optical signal repeater.

An object of the present disclosure is to provide an optical signal repeater and a failure determination method for an optical signal repeater that can execute autonomous detection of failure and execute redundancy switching.

### DESCRIPTION OF EMBODIMENTS OF THE INVENTION

First, embodiments of the present invention are enumerated.

(1) An optical signal repeater according to one aspect of the present invention includes: at least one first repeating unit configured to repeat an optical signal; at least one second repeating unit configured to be interchangeable with the first repeating unit; a branch portion configured to branch an optical signal and provide the branched optical signal to each of the first repeating unit and the second repeating unit; a failure determination unit configured to compare a signal output from the first repeating unit with a signal output from the second repeating unit, and determine presence or absence of failure in the first repeating unit; and a redundancy switching control unit configured to, if the failure determination unit determines the presence of failure in the first repeating unit, execute redundancy switching between the first repeating unit and the second repeating unit.

According to the above, an optical signal repeater can be provided that can execute autonomous detection of failure and execute redundancy switching. The optical signal repeater includes the first and second repeating units. The failure determination unit determines the presence or absence of failure in the first repeating unit by comparing the two optical signals that have passed through the two respective repeating units. Thus, the optical signal repeater can detect its own failure. Further, if the presence of failure in the first repeating unit is determined, redundancy switching can be performed by replacing the first repeating unit with the second repeating unit. A combination of “a signal output from the first repeating unit” and “a signal output from the second repeating unit” may be, for example, a combination of two optical signals that have been processed by the two respective repeating units, or a combination of an optical signal that has been processed by one of the repeating units and a signal representing the result of processing by the other of the repeating units, or a combination of two signals representing the results of processing by the two respective repeating units.

(2) In the optical signal repeater of the above (1), the branch portion is configured to branch an optical signal from the first repeating unit and generate a branch signal. The failure determination unit is configured to use the branch signal to determine the presence or absence of failure in the first repeating unit.

According to the above, an optical signal can be generated to determine the presence or absence of failure in the first repeating unit.

(3) In the optical signal repeater of the above (1) or (2), the number of the first repeating units is larger than the number of the second repeating units. The failure determination unit is configured to select a pair of the first repeating unit and the second repeating unit in order to compare the optical signals, and determine the presence or absence of failure in the first repeating unit that constitutes the pair.

According to the above, the presence or absence of failure can be determined for each of a plurality of first repeating units.

(4) In the optical signal repeater of the above (1) or (2), the failure determination unit is configured to select a combination of the first repeating unit and the second repeating unit in order to compare the optical signals, and determine the presence or absence of failure in the first repeating unit that constitutes the combination. The number of the first repeating units included in the combination is one, and the number of the second repeating units included in the combination is more than one.

According to the above, the presence or absence of failure in the first repeating unit can be more accurately determined.

(5) In the optical signal repeater of any one of the above (1) to (4), each of the first repeating unit and the second repeating unit is configured to execute 3R regeneration on the optical signal and output a digital signal. The failure determination unit is configured to determine the presence or absence of failure in the first repeating unit based on the digital signal from each of the first repeating unit and the second repeating unit.

According to the above, the failure determination unit can determine the presence or absence of failure in the first repeating unit by comparing the two optical signals that have passed through the two respective repeating units.

(6) A failure determination method for an optical signal repeater according to one aspect of the present invention is a failure determination method for an optical signal repeater configured to repeat an optical signal. The optical signal repeater includes a first repeating unit, a second repeating unit configured to be interchangeable with the first repeating unit, and a failure determination unit. The method includes: branching an optical signal and providing the branched optical signal to each of the first repeating unit and the second repeating unit; comparing, using the failure determination unit, a first signal output from the first repeating unit with a second signal output from the second repeating unit; and determining, using the failure determination unit, presence or absence of failure in the first repeating unit based on the result of the comparing of the first signal with the second signal.

According to the above, a failure in the optical signal repeater can be detected by the optical signal repeater itself.

### DETAILS OF EMBODIMENTS OF THE INVENTION

Embodiments of the present invention are hereinafter described with reference to the drawings. In the drawings, identical or corresponding components are identically denoted and the explanation for such components is not repeated. In each of the embodiments hereinafter described, a first repeating unit is referred to as an “active-system repeating unit”, and a second repeating unit is referred to as a “standby-system repeating unit”.

### First Embodiment

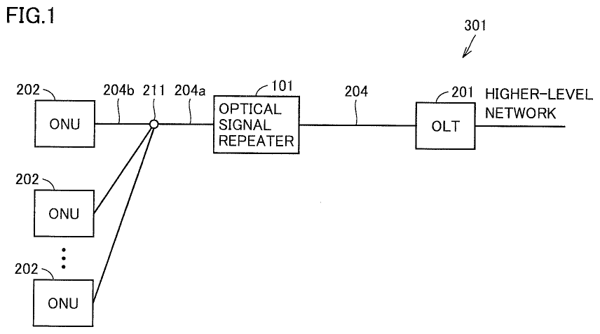

FIG. 1 shows an example configuration of an optical communication system in a first embodiment of the present invention. As shown in FIG. 1, an optical communication system 301 is a PON system, such as a GE-PON or a 10G-EPON or both. Optical communication system 301 includes an OLT 201 connected to a higher-level network, a trunk optical fiber 204, an access optical fiber 204a, leaf optical fibers 204b, an optical coupler 211, an optical signal repeater 101, and one or more optical network units (ONUs) 202.

OLT 201 is connected to trunk optical fiber 204. Optical signal repeater 101 is connected to trunk optical fiber 204 and access optical fiber 204a. Optical coupler 211 couples a plurality of leaf optical fibers 204b to access optical fiber 204a. Each of a plurality of leaf optical fibers 204b is connected to ONU 202. Optical signal repeater 101 repeats an optical signal from OLT 201 to each ONU 202 (i.e., a downstream signal), and repeats an optical signal from each ONU 202 to OLT 201 (i.e., an upstream signal).

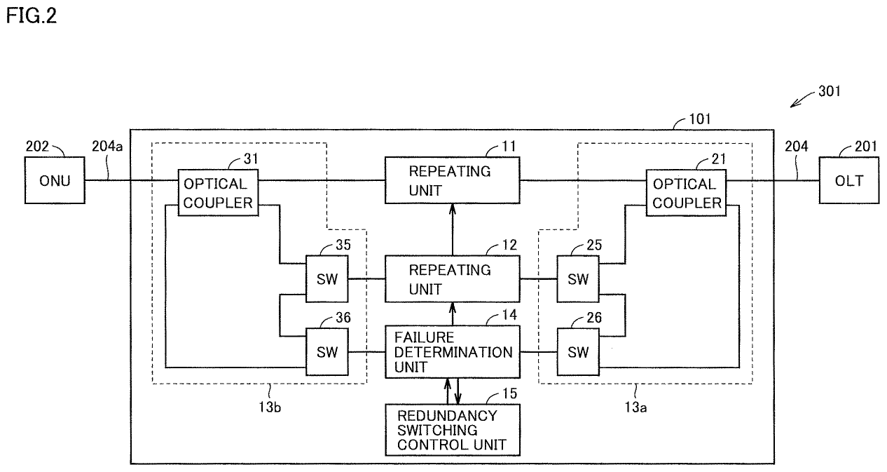

FIG. 2 is a block diagram showing a schematic configuration of optical signal repeater 101 in the first embodiment of the present invention. As shown in FIG. 2, optical signal repeater 101 includes repeating units 11, 12, branch portions 13a, 13b, a failure determination unit 14, and a redundancy switching control unit 15. In FIG. 2, for ease of understanding, ONU 202 is shown as being connected to access optical fiber 204a (ditto for the drawings described hereinafter).

Repeating units 11, 12 are configured to repeat an optical signal from OLT 201 to OW 202, and an optical signal from ONU 202 to OLT 201. As described in detail later, repeating units 11, 12 are the same in configuration. One of repeating units 11, 12 is an active-system repeating unit, and the other of repeating units 11, 12 is a standby-system repeating unit. That is, optical signal repeater 101 has a redundant configuration. If the active-system repeating unit is in failure, the standby-system repeating unit repeats an optical signal in place of the active-system repeating unit. In other words, redundancy switching is executed. In the examples hereinafter described, repeating unit 11 is an active-system repeating unit and repeating unit 12 is a standby-system repeating unit.

Branch portions 13a, 13b are configured to branch one optical signal into two optical signals. One of the two optical signals is sent to the active-system repeating unit. The other of the two optical signals is sent to the standby-system repeating unit.

Branch portion 13a and branch portion 13b are the same in configuration. Branch portion 13a includes an optical coupler 21 and switches 25, 26. Branch portion 13b includes an optical coupler 31 and switches 35, 36. Switches 25, 26, 35, 36 are controlled by, for example, failure determination unit 14.

Each of optical couplers 21, 31 is a 2×2 (2 inputs and 2 outputs) optical coupler. Optical coupler 21 is optically connected to trunk optical fiber 204, repeating unit 11, switch 25, and switch 26. Optical coupler 31 is optically connected to access optical fiber 204a, repeating unit 11, switch 35, and switch 36.

Each of switches 25, 26, 35, 36 is a 1×2 switch. Switch 25 is configured to switch between the path between optical coupler 21 and repeating unit 12, and the path between switch 26 and repeating unit 12. Switch 26 is configured to switch between the path between switch 25 and failure determination unit 14, and the path between optical coupler 21 and failure determination unit 14.

Switch 35 is configured to switch between the path between optical coupler 31 and repeating unit 12, and the path between switch 36 and repeating unit 12. Switch 36 is configured to switch between the path between switch 35 and failure determination unit 14, and the path between optical coupler 31 and failure determination unit 14.

Failure determination unit 14 is configured to compare the optical signal that has passed through the active-system repeating unit with the optical signal that has passed through the standby-system repeating unit, and determine whether or not the active-system repeating unit is in failure. Failure determination unit 14 determines the presence or absence of failure in the active-system repeating unit using at least one of an upstream signal and a downstream signal.

Redundancy switching control unit 15 is configured to execute redundancy switching between the active-system repeating unit and the standby-system repeating unit, based on the determination by failure determination unit 14. If at least one of the failure determination with the use of an upstream signal and the failure determination with the use of a downstream signal shows that the active-system repeating unit is in failure, redundancy switching control unit 15 executes redundancy switching.

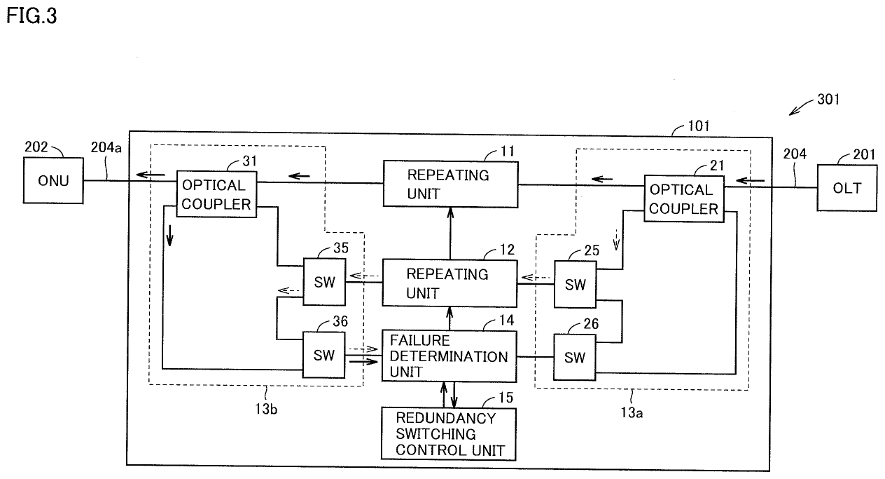

FIG. 3 is a diagram for illustrating the determination of the presence or absence of failure in a repeating unit with the use of a downstream signal by an optical signal repeater in the first embodiment of the present invention. As shown in FIG. 3, a downstream signal from OLT 201 is branched into two optical signals by optical coupler 21. These two respective optical signals are represented by solid arrows and dashed arrows.

Of the two optical signals, the optical signal represented by the solid arrows passes through repeating unit 11 and is sent to optical coupler 31. Optical coupler 31 bifurcates the optical signal. One of the optical signals is sent to ONU 202. The other of the optical signals is sent to switch 36 as a branch signal. The branch signal is transmitted to failure determination unit 14 through switch 36. As indicated by the solid arrows, repeating unit 11 repeats a downstream signal from OLT 201 to ONU 202. Optical coupler 31 can generate an optical signal for determination of the presence or absence of failure in repeating unit 11.

Of the two optical signals, the optical signal represented by the dashed arrows passes through switch 25 and is sent to repeating unit 12. The optical signal further passes through repeating unit 12 and is transmitted to failure determination unit 14 through switches 35, 36. Switch 36 switches between the two respective paths through which to transmit the optical signal represented by the solid arrows and the optical signal represented by the dashed arrows, so as to send these two optical signals to failure determination unit 14.

Failure determination unit 14 compares the optical signal from repeating unit 11 with the optical signal from repeating unit 12, and determines the presence or absence of failure in repeating unit 11. Failure determination unit 14 sends the determination result to redundancy switching control unit 15. If the presence of failure in repeating unit 11 is determined by failure determination unit 14, redundancy switching control unit 15 executes redundancy switching between repeating unit 11 and repeating unit 12. Specifically, switch 25 connects optical coupler 21 to repeating unit 12, and switch 35 connects optical coupler 31 to repeating unit 12. Further, redundancy switching control unit 15 stops repeating unit 11, after which repeating unit 12 repeats optical signals between OLT 201 and ONU 202.

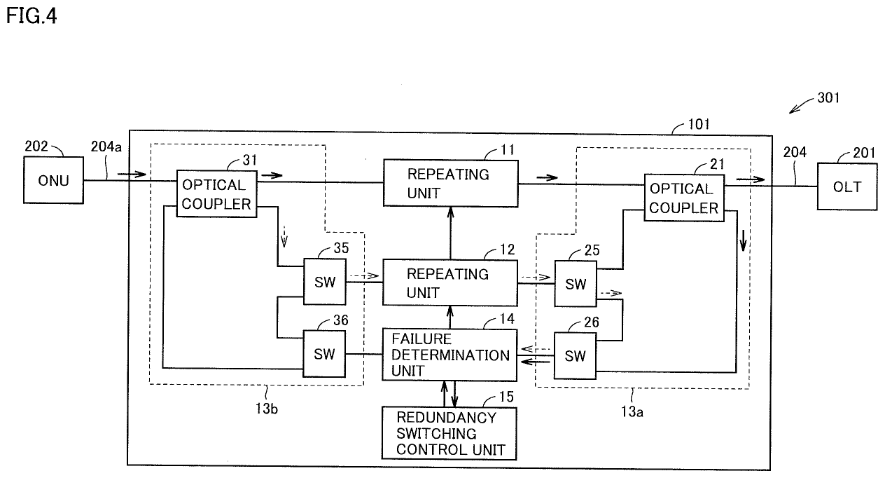

FIG. 4 is a diagram for illustrating the determination of the presence or absence of failure in a repeating unit with the use of an upstream signal by an optical signal repeater in the first embodiment of the present invention. As can be understood from the comparison between FIG. 3 and FIG. 4, the transmission direction of upstream signal is opposite to the transmission direction of downstream signal.

Branch portions 13a, 13b branch an optical signal. Specifically, an upstream signal from ONU 202 is branched into two optical signals by optical coupler 31. As in FIG. 3, these two respective optical signals are represented by solid arrows and dashed arrows in FIG. 4.

Of the two optical signals, the optical signal represented by the solid arrows passes through repeating unit 11 and is sent to optical coupler 21. Optical coupler 21 bifurcates the optical signal. One of the optical signals is sent to OLT 201. The other of the optical signals is sent to switch 26 as a branch signal. The branch signal is transmitted to failure determination unit 14 through switch 26. As indicated by the solid arrows, repeating unit 11 repeats an upstream signal from ONU 202 to OLT 201. Optical coupler 21 can generate an optical signal for determination of the presence or absence of failure in repeating unit 11.

Of the two optical signals, the optical signal represented by the dashed arrows passes through switch 35 and is sent to repeating unit 12. The optical signal further passes through repeating unit 12 and is transmitted to failure determination unit 14 through switches 25, 26. Switch 26 switches between the two respective paths through which to transmit the optical signal represented by the solid arrows and the optical signal represented by the dashed arrow's, so as to send these two optical signals to failure determination unit 14.

Failure determination unit 14 compares the optical signal from repeating unit 11 with the optical signal from repeating unit 12, and determines the presence or absence of failure in repeating unit 11. As described above, if the presence of failure in repeating unit 11 is determined, redundancy switching control unit 15 executes redundancy switching between repeating unit 11 and repeating unit 12.

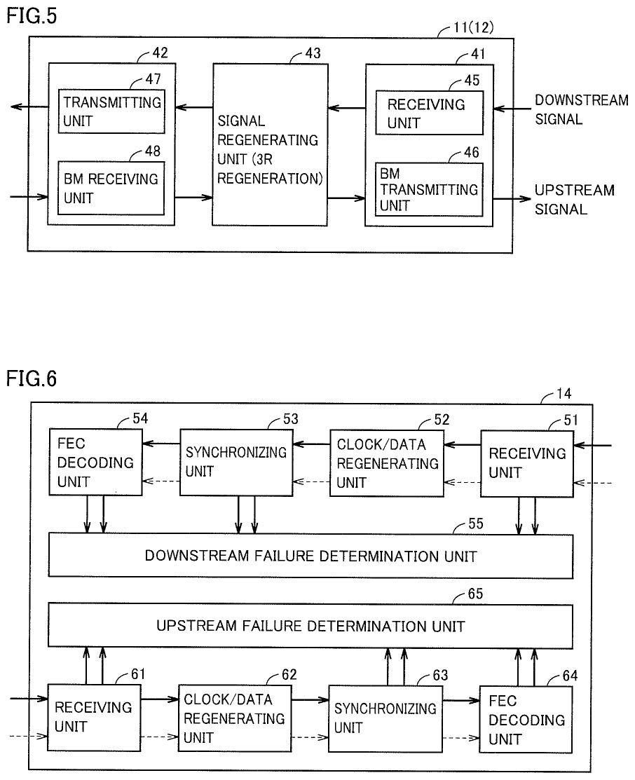

FIG. 5 is a block diagram showing an example configuration of repeating unit 11, 12 included in optical signal repeater 101 shown in FIG. 2. Since repeating unit 11 and repeating unit 12 are the same in configuration, repeating unit 12 is interchangeable with repeating unit 11. The configuration of repeating unit 11 is described as a representative hereinafter.

As shown in FIG. 5, repeating unit 11 includes optical transceivers 41, 42 and a signal regenerating unit 43. Each of optical transceivers 41, 42 is configured to transmit a downstream signal and an upstream signal. Optical transceiver 41 includes a receiving unit 45 and a burst mode (BM) transmitting unit 46. Optical transceiver 42 includes a transmitting unit 47 and a burst mode (BM) receiving unit 48.

Receiving unit 45 receives a downstream signal from OLT 201 (see FIG. 1). Transmitting unit 47 transmits the downstream signal to ONU 202 (see FIG. 1).

BM receiving unit 48 receives a burst optical signal, which is an upstream signal, from OW 202. BM transmitting unit 46 transmits the upstream signal to OLT 201.

Signal regenerating unit 43 regenerates a downstream signal from optical transceiver 41 to generate a data signal (digital signal). Similarly, signal regenerating unit 43 regenerates an upstream signal from optical transceiver 42 to generate a data signal (digital signal). Signal regenerating unit 43 executes 3R regenerative repeating on an optical signal: retiming, reshaping, and regenerating.

FIG. 6 is a block diagram showing an example configuration of failure determination unit 14 included in optical signal repeater 101 shown in FIG. 2. As shown in FIG. 6, failure determination unit 14 includes receiving units 51, 61, clock/data regenerating units 52, 62, synchronizing units 53, 63, forward error correction (FEC) decoding units 54, 64, a downstream failure determination unit 55, and an upstream failure determination unit 65. The solid arrows and the dashed arrows shown in FIG. 6 respectively correspond to the solid arrows and the dashed arrows shown in each of FIG. 3 and FIG. 4.

Receiving unit 51 receives two optical signals (downstream signals) and transmits a signal representing the result of the reception to downstream failure determination unit 55.

Clock/data regenerating unit 52 receives the two optical signals from receiving unit 51. Clock/data regenerating unit 52 regenerates a clock signal from each optical signal. Further, clock/data regenerating unit 52 regenerates data (digital signal) from each optical signal using the regenerated clock signal.

Synchronizing unit 53 performs code synchronization and outputs a signal representing the result (synchronization or synchronization error). For example, synchronizing unit 53 outputs a signal representing the result of the synchronization with respect to a sync pattern that is given in front of a user data area. Alternatively, synchronizing unit 53 outputs a signal representing the result of the synchronization of a 64B/66B code (for 10G-EPON) or a 8B/10B code (for GE-PON) of a user data area.

FEC decoding unit 54 performs error correction (FEC) and decoding on data and generates a digital signal. Further, FEC decoding unit 54 transmits a signal representing the result of this process to downstream failure determination unit 55.

Downstream failure determination unit 55 determines the presence or absence of failure in repeating unit 11 based on the signal from receiving unit 51, the signal from synchronizing unit 53, and the signal from FEC decoding unit 54.

Receiving unit 61, clock/data regenerating unit 62, synchronizing unit 63, and FEC decoding unit 64 respectively have the same functions as those of receiving unit 51, clock/data regenerating unit 52, synchronizing unit 53, and FEC decoding unit 54 except that a downstream signal is replaced by an upstream signal. Upstream failure determination unit 65 determines the presence or absence of failure in repeating unit 11 based on the signal from receiving unit 61, the signal from synchronizing unit 63, and the signal from FEC decoding unit 64.

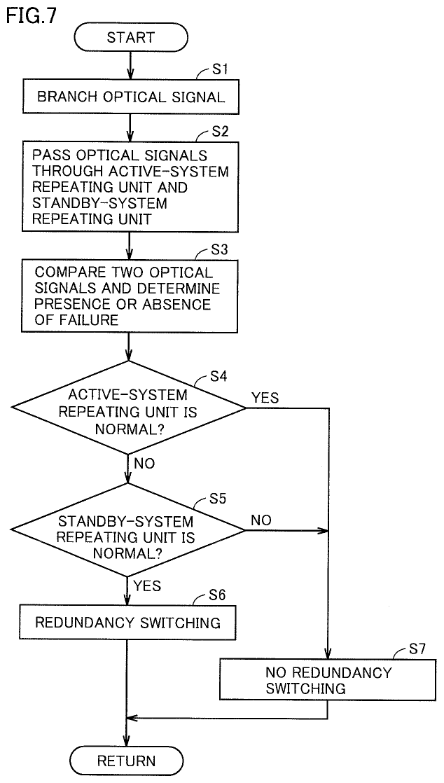

FIG. 7 is a flowchart illustrating the determination of the presence or absence of failure in a repeating unit and redundancy switching by optical signal repeater 101 in the first embodiment of the present invention. The processing shown in this flowchart is repeatedly executed, for example, in a constant cycle. The processes of a plurality of steps in the flowchart may be executed concurrently.

As shown in FIG. 7, with the onset of the processing, branch portions 13a, 13b branch an optical signal (downstream signal or upstream signal) at step S1. At step S2, the two respective optical signals are passed through an active-system repeating unit (repeating unit 11) and a standby-system repeating unit (repeating unit 12).

At step S3, failure determination unit 14 compares the two optical signals that have passed through the active-system repeating unit and the standby-system repeating unit, and determines the presence or absence of failure in the active-system repeating unit. For example, in the case of determination based on a downstream signal, downstream failure determination unit 55 can determine the presence or absence of failure in the active-system repeating unit in the following way.

Failure determination unit 14 checks the input levels of the two optical signals using a signal from receiving unit 51. If the input level of the optical signal from the active-system repeating unit is abnormal and the input level of the optical signal from the standby-system repeating unit is normal, then failure determination unit 14 determines the presence of failure in the active-system repeating unit.

Failure determination unit 14 checks the result of the code synchronization using a signal from synchronizing unit 53. If receiving a signal representing synchronization error from synchronizing unit 53, failure determination unit 14 determines the presence of failure in the active-system repeating unit.

Failure determination unit 14 checks the result of the FEC decoding using a signal from FEC decoding unit 54. If an error has occurred at the time of decoding of the data from the optical signal that has passed through the active-system repeating unit, and the data from the optical signal that has passed through the standby-system repeating unit has been normally decoded, then the presence of failure in the active-system repeating unit is determined.

In the case of determination based on an upstream signal, upstream failure determination unit 65 determines the presence or absence of failure in the active-system repeating unit in the same way as above. The method of determination by upstream failure determination unit 65 is different from the method of determination by downstream failure determination unit 55 in that a signal from each of receiving unit 61, synchronizing unit 63, and FEC decoding unit 64 is used instead of a signal from each of receiving unit 51, synchronizing unit 53, and FEC decoding unit 54. Note that, in this embodiment, failure determination unit 14 does not receive two optical signals at the same time. Therefore, “the comparison between the two optical signals” does not mean that the two optical signals are sequentially compared with each other with respect to each item (e.g. input level) of optical signal. In this embodiment, failure determination unit 14 checks for an error for each item (e.g. input level) with respect to one of the optical signals, and then checks for an error for each item with respect to the other of the optical signals in the same way. Failure determination unit 14 then compares the results of the checks with each other and determines the presence or absence of failure in the active-system repeating unit.

At step S4, failure determination unit 14 determines whether or not the active-system repeating unit is normal. If the active-system repeating unit is normal (YES at step S4), the redundancy switching is not performed (step S7).

If the active-system repeating unit is determined to be abnormal (NO at step S4), failure determination unit 14 determines whether or not the standby-system repeating unit is normal at step S5. If the standby-system repeating unit is normal (YES at step S5), redundancy switching control unit 15 executes the redundancy switching (step S6). On the other hand, if the standby-system repeating unit is determined to be abnormal (NO at step S5), the redundancy switching is not performed (step S7).

According to the first embodiment, optical signal repeater 101 can autonomously detect a failure within itself. Further, optical signal repeater 101 can autonomously execute the redundancy switching.

### Second Embodiment

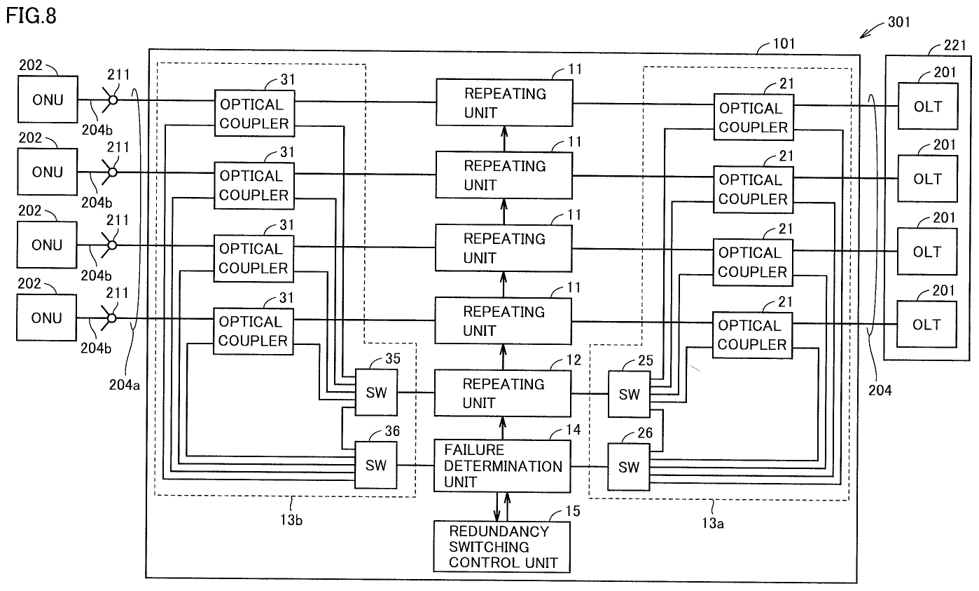

FIG. 8 is a block diagram showing optical communication system 301 and optical signal repeater 101 in a second embodiment of the present invention. As shown in FIG. 8, in the second embodiment, optical communication system 301 includes a plurality of repeater lines. Specifically, optical communication system 301 includes a plurality of OLTs 201. In the example of FIG. 8, four OLTs 201 are contained in one OLT package 221. Each OLT 201 is connected to at least one ONU 202 through optical signal repeater 101. FIG. 8 representatively shows four OLTs 201, and four ONUs each connected to a corresponding one of four OLTs 201.

Optical signal repeater 101 includes the same number of active-system repeating units 11 as the number of the OLTs. FIG. 8 representatively shows four repeating units 11.

Optical signal repeater 101 further includes at least one standby-system repeating unit (repeating unit 12). The number of the standby-system repeating units is one or more and smaller than the number of the active-system repeating units. FIG. 8 shows a case where the number of repeating units 12 is one.

Optical signal repeater 101 further includes branch portions 13a, 13b. Each of branch portions 13a, 13b includes the same number of optical couplers as the number of active-system optical repeating units. In the example shown in FIG. 8, branch portion 13a includes four optical couplers 21, and branch portion 13b includes four optical couplers 31. As in the configuration shown in FIG. 2, each optical coupler 21 is connected to trunk optical fiber 204, repeating unit 11, switch 25, and switch 26. Each optical coupler 31 is connected to access optical fiber 204a, repeating unit 11, switch 35, and switch 36. Note that, in the example shown in FIG. 8, each of switches 25, 26, 35, 36 is a 1×5 switch.

The other part of the optical signal repeater shown in FIG. 8 is the same in configuration as the corresponding part shown in FIG. 2. Thus, the explanation for the same configuration is not repeated.

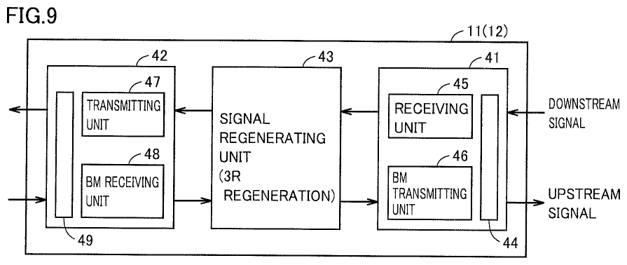

FIG. 9 is a block diagram showing an example configuration of repeating unit 11, 12 included in optical signal repeater 101 shown in FIG. 8. As in the first embodiment, repeating unit 11 and repeating unit 12 are the same in configuration. The configuration of repeating unit 11 is described as a representative hereinafter.

As shown in FIG. 9, optical transceivers 41, 42 may include a wavelength division multiplexing communication (WDM) unit 44 and a WDM unit 49, respectively. The other part of repeating unit 11 shown in FIG. 9 is the same in configuration as the corresponding part shown in FIG. 5. Thus, the explanation for the same configuration is not repeated. WDM unit 44 is configured to perform wavelength division multiplexing communication with a plurality of wavelength-selective OLTs. WDM unit 49 is configured to perform wavelength division multiplexing communication with a plurality of wavelength-selective ONUS. Note that, in the second embodiment, WDM units 44, 49 are not essential components of repeating units 11, 12 but are optional example components. Therefore, repeating units 11, 12 do not necessarily have to include WDM units 44, 49.

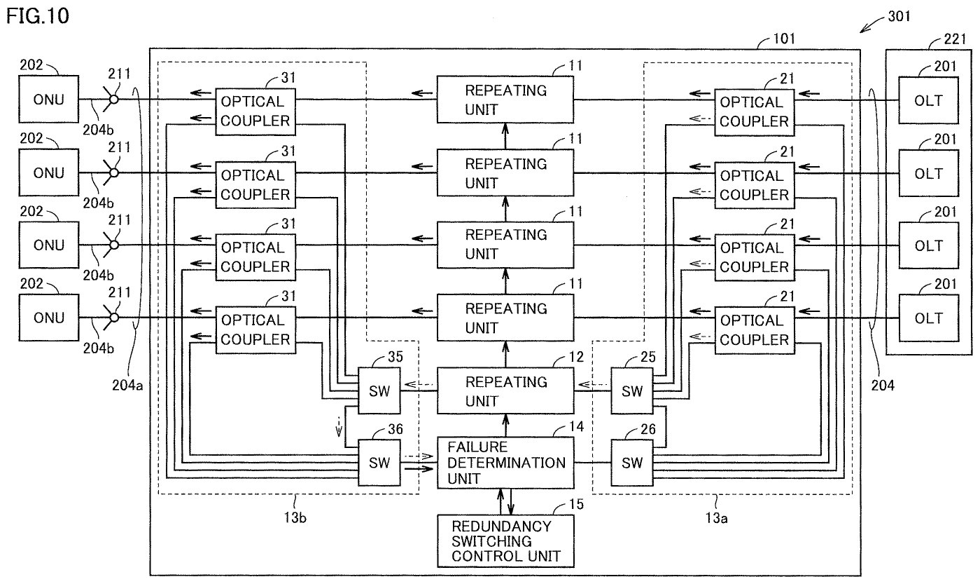

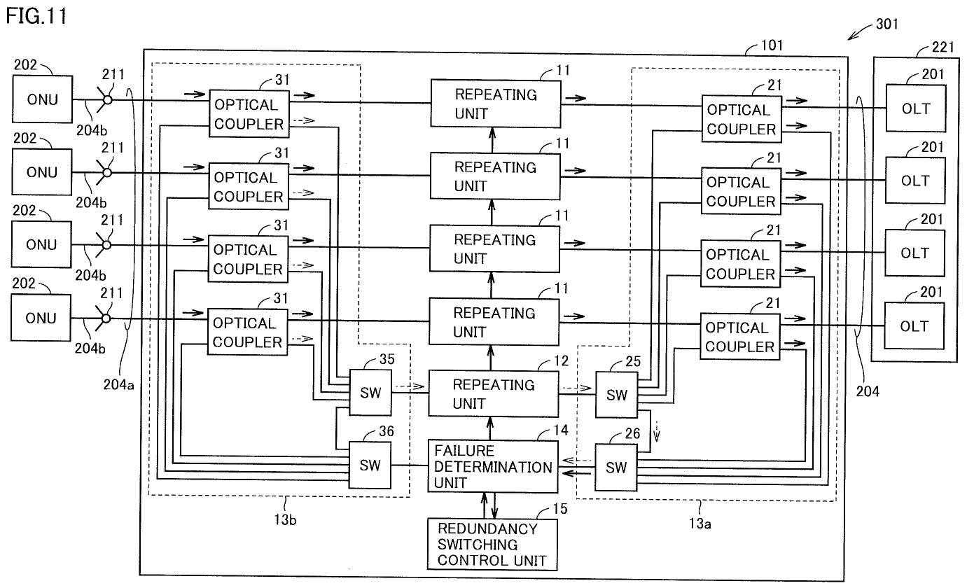

FIG. 10 is a diagram for illustrating the determination of the presence or absence of failure of a repeating unit with the use of a downstream signal by an optical signal repeater in the second embodiment of the present invention. FIG. 11 is a diagram for illustrating the determination of the presence or absence of failure in a repeating unit with the use of an upstream signal by an optical signal repeater in the second embodiment of the present invention. FIG. 10 and FIG. 11 are contrasted with FIG. 3 and FIG. 4, respectively.

As shown in FIG. 10 and FIG. 11, in the second embodiment, optical signal repeater 101 includes a plurality of active-system repeating units (repeating units 11) and a standby-system repeating unit (repeating unit 12) less in number than the number of the active-system repeating units.

Failure determination unit 14 selects a pair of one of a plurality of active-system repeating units and a standby-system repeating unit, and determines the presence or absence of failure in the active-system repeating unit (repeating unit 11) that constitutes the pair. If the presence of failure in the active-system repeating unit is determined, redundancy switching control unit 15 executes the redundancy switching between the repeating unit and the standby-system repeating unit. The determination of the presence or absence of failure using the pair of repeating units and the redundancy switching are the same as the determination of the presence or absence of failure in a repeating unit and the redundancy switching of the first embodiment (see FIG. 7).

As shown in FIG. 10, in the failure determination with the use of a downstream signal, one repeating unit is selected from among a plurality of repeating units 11. Switch 25 establishes a transmission path so that the optical signal (represented by the dashed arrows) from optical coupler 21 connected to the selected repeating unit is sent to repeating unit 12. The optical signal that has passed through repeating unit 12 is sent to failure determination unit 14 via switches 35, 36.

On the other hand, the optical signal (represented by the solid arrows) from optical coupler 31 connected to the selected repeating unit is sent to failure determination unit 14 via switch 36. Switch 36 switches between the two paths through which to transmit the two respective optical signals, so as to transmit these two optical signals to failure determination unit 14.

As shown in FIG. 11, in the failure determination with the use of an upstream signal, switch 35 establishes a transmission path so that the optical signal (represented by the dashed arrows) from optical coupler 31 connected to the selected repeating unit is sent to repeating unit 12. The optical signal that has passed through repeating unit 12 is sent to failure determination unit 14 via switches 25, 26. Further, the optical signal (represented by the solid arrows) from optical coupler 21 connected to the selected repeating unit 11 is sent to failure determination unit 14 via switch 26.

According to the second embodiment, the failure determination can be performed for each of a plurality of active-system repeating units. Further, the redundancy switching can be performed between a failed repeating unit and a standby-system repeating unit.

### Third Embodiment

In the second embodiment, only a failed repeating unit among a plurality of active-system repeating units is switched to a standby-system repeating unit. In the third embodiment, the redundancy switching can be executed between a group of active-system repeating units and a group of standby-system repeating units.

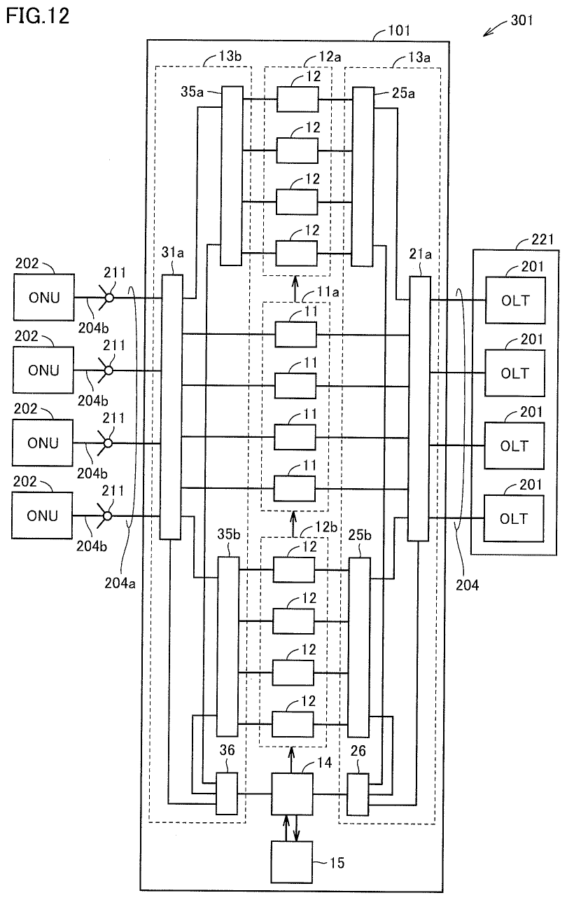

FIG. 12 is a block diagram schematically showing optical communication system 301 and optical signal repeater 101 in the third embodiment of the present invention. As shown in FIG. 12, four OLTs 201 are contained in one OLT package 221, for example. Optical signal repeater 101 includes repeater packages 11a, 12a, 12b.

Each of repeater packages 11a, 12a, 12b includes four repeating units. Specifically, repeater package 11a contains four active-system repeating units (repeating units 11). Each of repeater packages 12a, 12b contains four standby-system repeating units (repeating units 12).

For sake of simplicity, one OLT package 221, and one repeater package 11a corresponding to the OLT package 221 are shown in FIG. 12. Optical communication system 301, however, may have a plurality of OLT packages 221. In such a configuration, optical signal repeater 101 has a plurality of repeater packages 11a.

Optical signal repeater 101 further includes branch portions 13a, 13b, failure determination unit 14, and redundancy switching control unit 15. Branch portion 13a includes an optical coupler unit 21a and switch units 25a, 25b. Branch portion 13b includes an optical coupler unit 31a and switch units 35a, 35b.

Each of optical coupler units 21a, 31a includes four optical couplers (not shown). Each of switch units 25a, 25b includes four switches (not shown). That is, the number of optical couplers included in each of optical coupler units 21a, 31a is the same as the number of OLTs 201 included in OLT package 221 and the same as the number of repeater packages included in each of repeater packages 11a, 12a, 12b. The number of switches included in each of switch units 25a, 25b is also the same as the number of OLTs 201 included in OLT package 221 and the same as the number of repeater packages included in each of repeater packages 11a, 12a, 12b.

Failure determination unit 14 selects one of four repeating units 11 included in repeater package 11a. Further, failure determination unit 14 selects one of four repeating units 12 included in repeater package 12a and one of four repeating units 12 included in repeater package 12b. Failure determination unit 14 determines the presence or absence of failure in repeating unit 11 (active-system repeating unit) based on the comparison among three optical signals that have passed through the three respective repeating units. That is, failure determination unit 14 selects a combination of one active-system repeating unit and a plurality of standby-system repeating units, and determines the presence or absence of failure in the active-system repeating unit based on the comparison among the signals that have passed through the respective repeating units that constitute the combination.

For example, failure determination unit 14 determines the presence or absence of failure in the active-system repeating unit in the following way. Failure determination unit 14 compares the optical signal from repeating unit 11 with the optical signal from one of two repeating units 12. Further, failure determination unit 14 compares the optical signal from repeating unit 11 with the optical signal from the other of two repeating units 12. If at least the results of these two comparisons are normal, failure determination unit 14 determines repeating unit 11 to be normal. Thus, the redundancy switching is not executed.

On the other hand, if the result of the comparison between the optical signal from repeating unit 11 and the optical signal from one of two repeating units 12 shows abnormality, failure determination unit 14 compares the optical signal from repeating unit 11 with the optical signal from the other of two repeating units 12. If the result of the comparison shows abnormality, failure determination unit 14 determines the presence of failure in repeating unit 11.

If the comparison between the optical signal from repeating unit 11 and the optical signal from one of repeating units 12 shows abnormality, it may not be possible to identify which of repeating units 11, 12 is in failure. On the other hand, it is unlikely that two standby-system repeating units selected from two respective different repeater packages are in failure at the same time. Hence, a comparison is made between the optical signal from repeating unit 11 and the optical signal from the other of repeating units 12. If the comparison result is abnormal, the comparison result with the two objects of comparison (repeating units 12) shows abnormality. Therefore, the presence of failure in repeating unit 11 is determined. Such determination allows accurate determination of the presence or absence of failure in repeating unit 11.

If the presence of failure in repeating unit 11 is determined, redundancy switching control unit 15 executes the redundancy switching between repeater package 11a and one of repeater packages 12a, 12b.

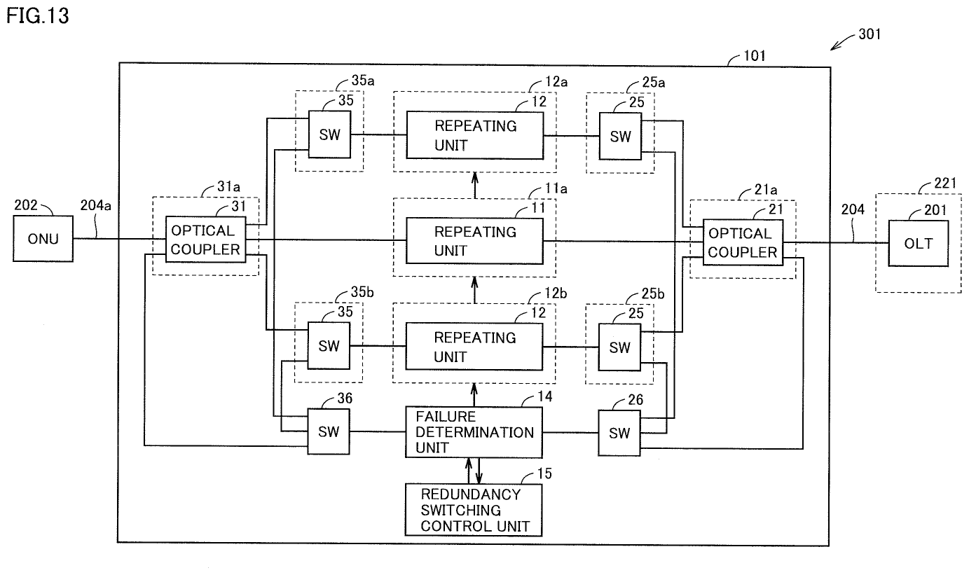

FIG. 13 is a block diagram showing a part of optical communication system 301 in the third embodiment of the present invention. FIG. 13 shows one repeating unit included in each of repeater packages 11a, 12a, 12b and a configuration related to the repeating unit. Each of repeating units 11, 12 is the same in configuration as the one shown in FIG. 9, and thus the explanation for the same configuration is not repeated.

Optical coupler units 21a, 31a include optical couplers 21, 31, respectively. Each of optical couplers 21, 31 is a 2×3 optical coupler. Optical coupler 21 is connected to trunk optical fiber 204, repeating unit 11, and two switches 25 and 26. Optical coupler 31 is connected to access optical fiber 204a, repeating unit 11, and two switches 35 and 36.

Each of switch units 25a, 25b includes switch 25. Switch 25 is a 1×2 switch and is configured to switch between the path between optical coupler 21 and repeating unit 12, and the path between switch 26 and repeating unit 12.

Each of switch units 35a, 35b includes switch 35. Switch 35 is a 1×2 switch and is configured to switch between the path between optical coupler 31 and repeating unit 12, and the path between switch 36 and repeating unit 12.

Each of switches 26, 36 is a 1×3 switch. Switch 26 is configured to switch among the path between switch 25 included in switch unit 25a and failure determination unit 14, the path between switch 25 included in switch unit 25b and failure determination unit 14, and the path between optical coupler 21 and failure determination unit 14. Switch 36 is configured to switch among the path between switch 35 included in switch unit 35a and failure determination unit 14, the path between switch 35 included in switch unit 35b and failure determination unit 14, and the path between optical coupler 31 and failure determination unit 14.

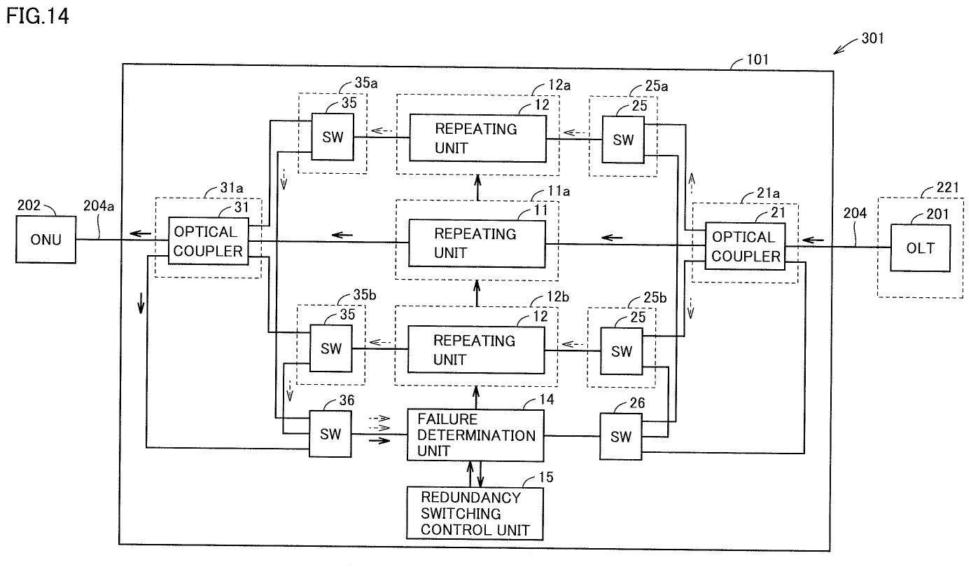

FIG. 14 is a diagram for illustrating the determination of the presence or absence of failure in a repeating unit with the use of a downstream signal by an optical signal repeater in the third embodiment of the present invention. As shown in FIG. 14, a downstream signal from OLT 201 is branched into three optical signals by optical coupler 21. A signal that is input to an active-system repeating unit (repeating unit 11) is represented by solid arrows. A signal that is input to a standby-system repeating unit (repeating unit 12) is represented by dashed arrows.

The optical signal represented by the solid arrows passes through repeating unit 11 and is sent to optical coupler 31. Optical coupler 31 bifurcates the optical signal. One of the optical signals is sent to ONU 202. The other of the optical signals is sent to switch 36 and is transmitted to failure determination unit 14 through switch 36.

One of the two optical signals represented by the dashed arrows passes through switch 25 of switch unit 25a, repeating unit 12 of repeater package 12a, and switch 35 of switch unit 35a, and is transmitted to failure determination unit 14 through switch 36. The other of the two optical signals represented by the dashed arrows passes through switch 25 of switch unit 25b, repeating unit 12 of repeater package 12b, and switch 35 of switch unit 35b, and is transmitted to failure determination unit 14 through switch 36. Switch 36 switches among the three paths through which to transmit the three respective optical signals.

Failure determination unit 14 receives the optical signal from repeating unit 11 and the two optical signals from two respective repeating units 12, and determines the presence or absence of failure in repeating unit 11. If the presence of failure in repeating unit 11 is determined, redundancy switching control unit 15 executes the redundancy switching between repeater package 11a and one of repeater packages 12a, 12b.

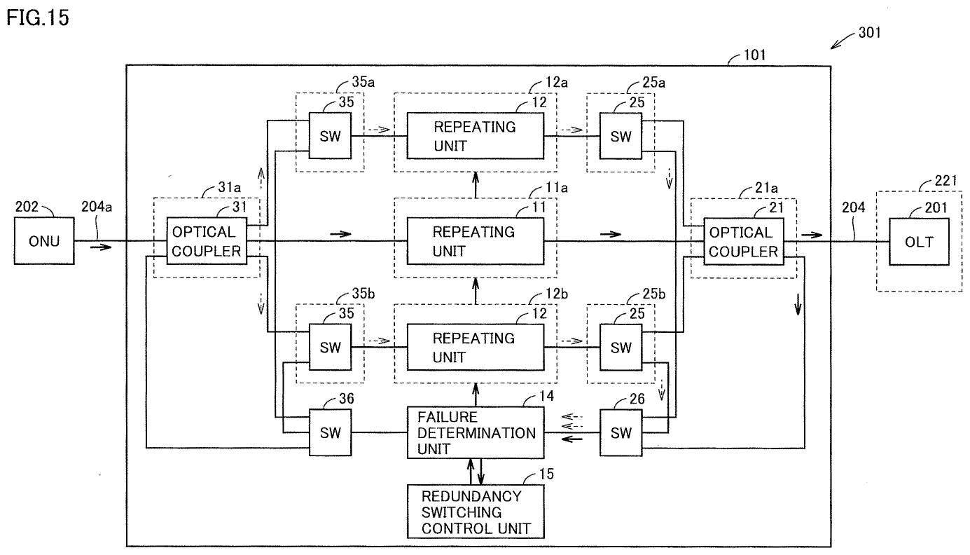

FIG. 15 is a diagram for illustrating the determination of the presence or absence of failure in a repeating unit with the use of an upstream signal by an optical signal repeater in the third embodiment of the present invention. As shown in FIG. 15, an upstream signal from ONU 202 is branched into three optical signals by optical coupler 31.

Of the three optical signals, the optical signal represented by the solid arrows passes through repeating unit 11 and is sent to optical coupler 21. Optical coupler 31 bifurcates the optical signal. One of the optical signals is sent to OLT 201. The other of the optical signals is sent to switch 26 and is transmitted to failure determination unit 14 through switch 26.

One of the two optical signals represented by the dashed arrows passes through switch 35 of switch unit 35a, repeating unit 12 of repeater package 12a, and switch 25 of switch unit 25a, and is transmitted to failure determination unit 14 through switch 26. The other of the two optical signals represented by the dashed arrows passes through switch 35 of switch unit 35b, repeating unit 12 of repeater package 12b, and switch 25 of switch unit 25b, and is transmitted to failure determination unit 14 through switch 26. Switch 26 switches among the three paths through which to transmit the three respective optical signals.

Failure determination unit 14 compares the optical signal from repeating unit 11 with the optical signal from repeating unit 12, and determines the presence or absence of failure in repeating unit 11. If the presence of failure in repeating unit 11 is determined, redundancy switching control unit 15 executes the redundancy switching between repeater package 11a and one of repeater packages 12a, 12b.

As described above, according to the third embodiment, one active-system repeating unit is combined with a plurality of standby-system repeating units. The presence or absence of failure in the active-system repeating unit is determined by comparison among the signals that have passed through the respective repeating units.

Note that an active-system repeating unit may be configured to, when repeating an optical signal, notify the result of the repeating process to failure determination unit 14. Such an embodiment is described hereinafter.

### Fourth Embodiment

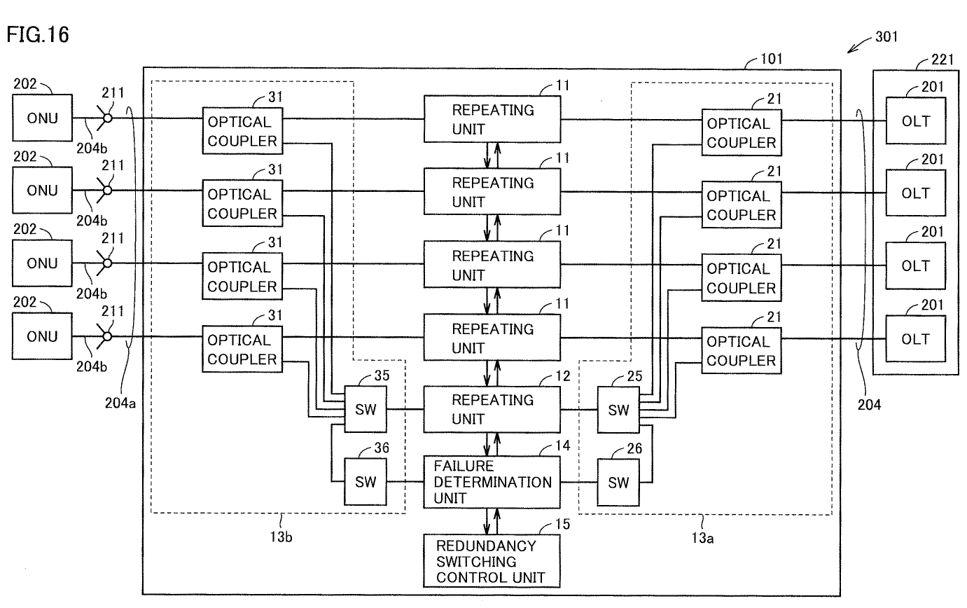

FIG. 16 is a block diagram showing optical communication system 301 and optical signal repeater 101 in a fourth embodiment of the present invention. FIG. 16 being compared with FIG. 8, each of optical couplers 21, 31 is a 1×2 optical coupler in the fourth embodiment. Switch 26 is configured to form a path between switch 25 and failure determination unit 14. Switch 36 is configured to form a path between switch 35 and failure determination unit 14.

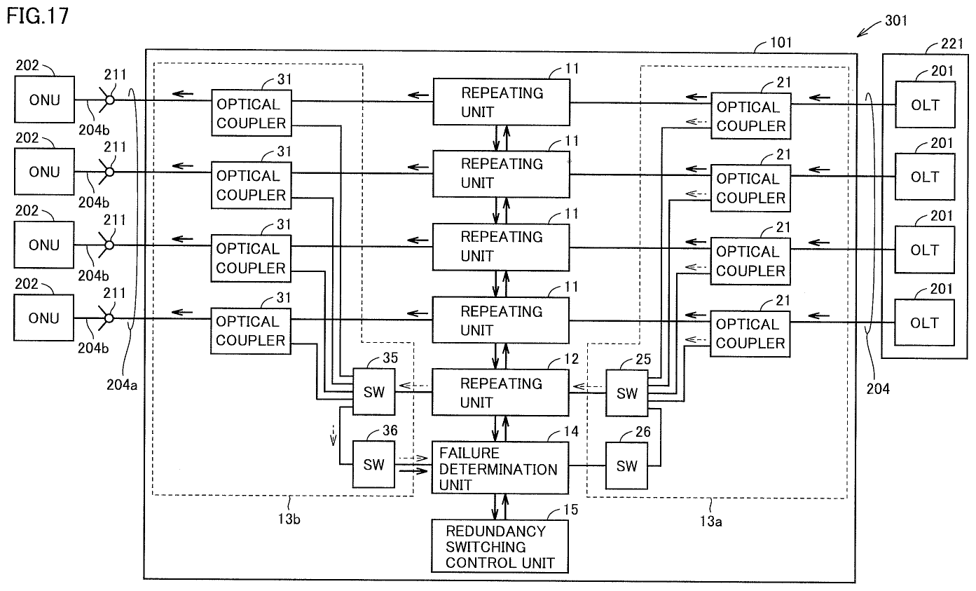

FIG. 17 is a diagram for illustrating the determination of the presence or absence of failure in a repeating unit with the use of a downstream signal by an optical signal repeater in the fourth embodiment of the present invention. As shown in FIG. 17, a downstream signal from OLT 201 is branched into two optical signals by optical coupler 21. The optical signal represented by the solid arrows passes through repeating unit 11 and optical coupler 31, and is transmitted to ONU 202.

Repeating unit 11 receives the optical signal, executes a repeating process, and outputs the result of the repeating process. Repeating unit 11 is basically the same in configuration as the one shown in FIG. 9. Each block shown in FIG. 9 outputs a signal representing the result of a process. For example, receiving unit 51 outputs a signal representing the level of input optical signal to failure determination unit 14. Signal regenerating unit 43 outputs, to failure determination unit 14, a signal related to the result of code synchronization and a signal representing the result of FEC decoding.

Failure determination unit 14 determines the presence or absence of failure using a pair of repeating units. That is, one of a plurality of repeating units 11 and repeating unit 12 form a pair. For example, failure determination unit 14 can determine the presence or absence of failure in selected repeating unit 11 based on the signal from the repeating unit 11 and based on the optical signal that has passed through repeating unit 12 and has been input to failure determination unit 14. Such a determination method is described hereinafter. However, repeating unit 12 may send failure determination unit 14 a signal representing the result of the repeating process of optical signal. Failure determination unit 14 may determine the presence or absence of failure in selected repeating unit 11 based on the signal from the repeating unit 11 and based on the signal from repeating unit 12.

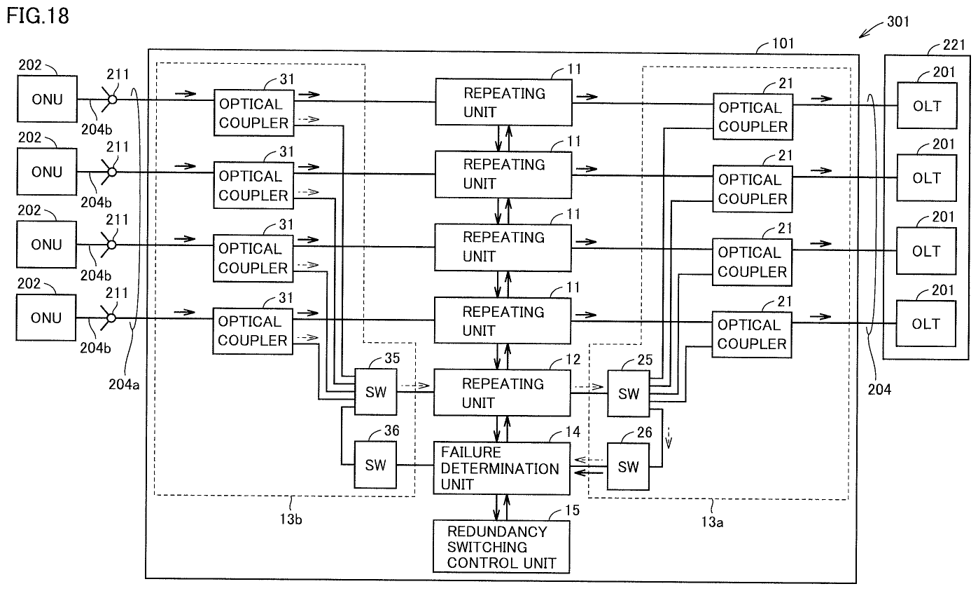

FIG. 18 is a diagram for illustrating the determination of the presence or absence of failure in a repeating unit with the use of an upstream signal by an optical signal repeater in the fourth embodiment of the present invention. As shown in FIG. 18, an upstream signal from ONU 202 is branched into two optical signals by optical coupler 21. The optical signal represented by the solid arrows passes through repeating unit 11 and optical coupler 21 and is transmitted to OLT 201. Repeating unit 11 receives the optical signal, executes a repeating process, and outputs the result of the repeating process. Failure determination unit 14 determines the presence or absence of failure in selected repeating unit 11 based on the signal from the repeating unit 11 and based on the optical signal that has passed through repeating unit 12 and has been input to failure determination unit 14.

The other part of the optical signal repeater in the fourth embodiment is the same in configuration as that of the optical signal repeater in the second embodiment. According to the fourth embodiment, the failure determination can be performed for each of a plurality of active-system repeating units, as in the second embodiment. Further, the redundancy switching can be performed between a failed repeating unit and a standby-system repeating unit.

### Fifth Embodiment

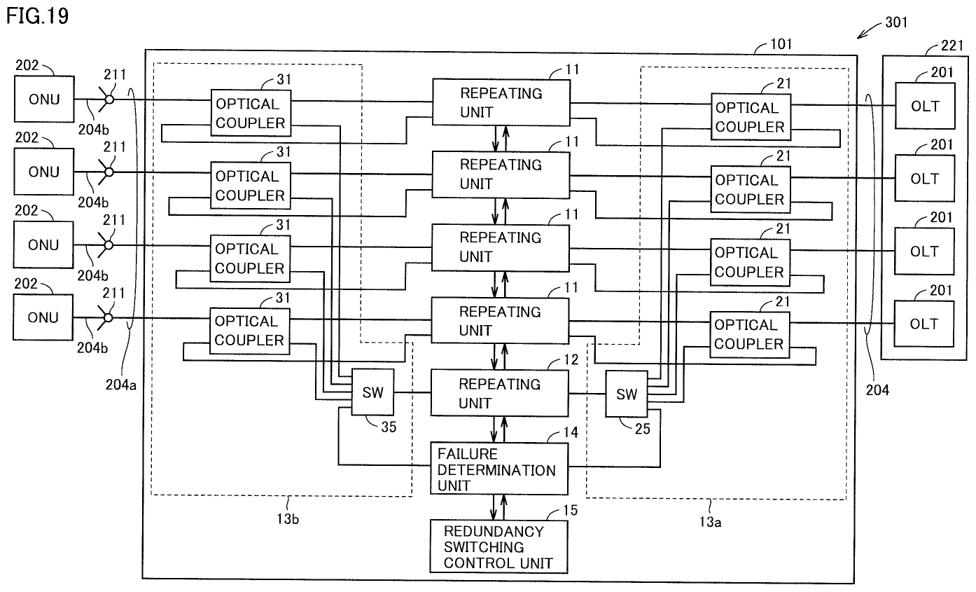

FIG. 19 is a block diagram showing optical communication system 301 and optical signal repeater 101 in a fifth embodiment of the present invention. FIG. 19 being compared with FIG. 8, optical signal repeater 101 in the fifth embodiment is different from optical signal repeater 101 in the second embodiment in the following respects.

In the fifth embodiment, optical signal repeater 101 does not include switches 26, 36. In the second embodiment, one of the four ports of optical coupler 21 is connected to switch 26. In the fifth embodiment, on the other hand, the port is connected to repeating unit 11. In the second embodiment, one of the four ports of optical coupler 31 is connected to switch 36. In the fifth embodiment, on the other hand, the port is connected to repeating unit 11.

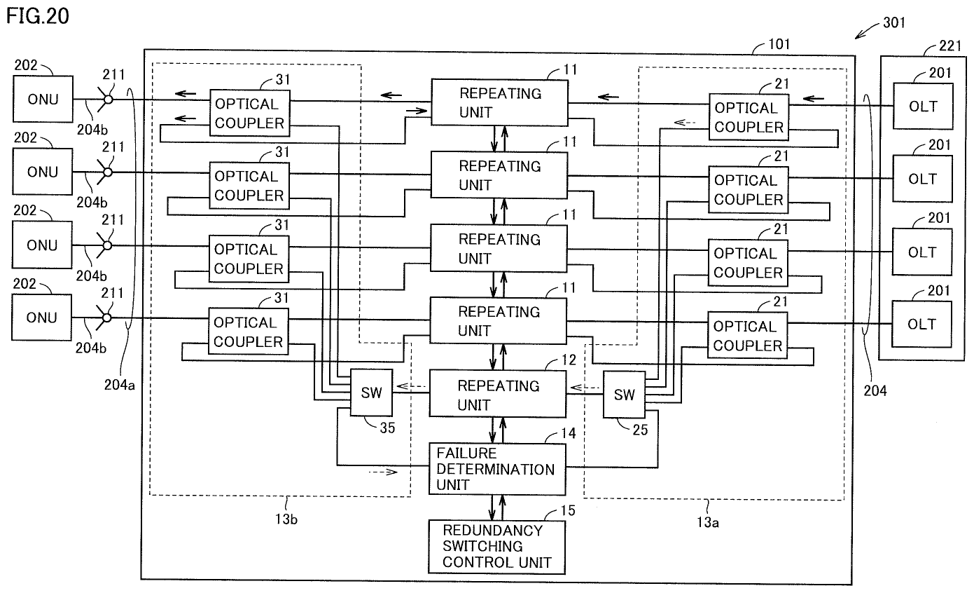

FIG. 20 is a diagram for illustrating the determination of the presence or absence of failure in a repeating unit with the use of a downstream signal by an optical signal repeater in the fifth embodiment of the present invention. As shown in FIG. 20, a downstream signal from OLT 201 is branched into two optical signals by optical coupler 21. The optical signal represented by the solid arrows passes through repeating unit 11 and is sent to optical coupler 31. Optical coupler 31 bifurcates the optical signal. One of the optical signals is sent to ONU 202. The other of the optical signals is returned to repeating unit 11.

Repeating unit 11 uses the optical signal returned from optical coupler 31 to output a signal representing the result of the repeating process by repeating unit 11. As in the fourth embodiment, repeating unit 11 outputs, to failure determination unit 14, a signal representing the level of input optical signal, a signal related to the result of code synchronization, and a signal representing the result of FEC decoding.

The optical signal represented by the dashed arrows passes through switch 25 and is sent to repeating unit 12. The optical signal further passes through repeating unit 12 and is transmitted to failure determination unit 14 through switch 35.

As in the fourth embodiment, failure determination unit 14 determines the presence or absence of failure using a pair of repeating units. That is, one of a plurality of repeating units 11 and repeating unit 12 form a pair. Failure determination unit 14 determines the presence or absence of failure in selected repeating unit 11 based on the signal from the repeating unit 11 and based on the optical signal that has passed through repeating unit 12 and has been input to failure determination unit 14.

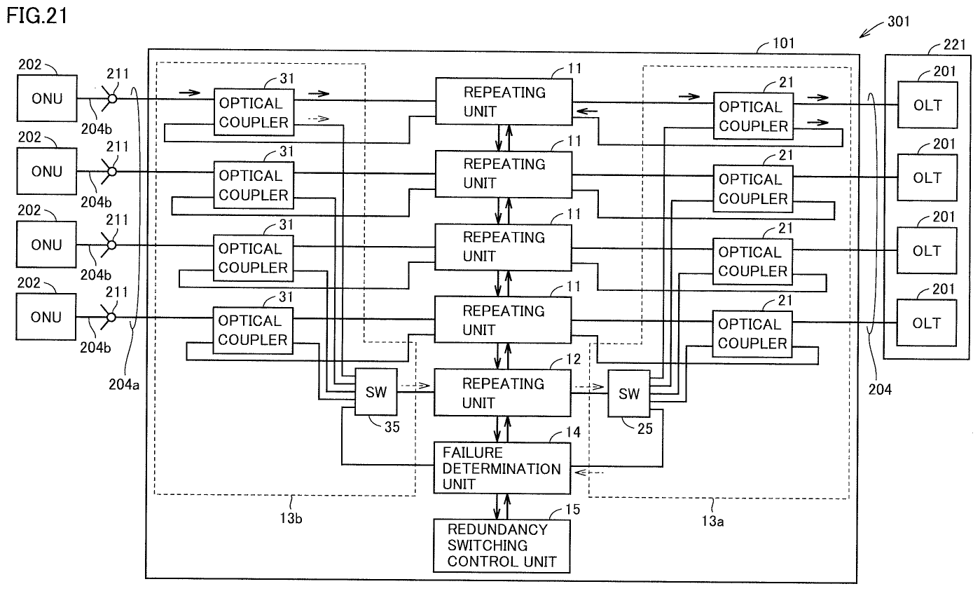

FIG. 21 is a diagram for illustrating the determination of the presence or absence of failure in a repeating unit with the use of an upstream signal by an optical signal repeater in the fifth embodiment of the present invention. As shown in FIG. 21, an upstream signal from ONU 202 is branched into two optical signals by optical coupler 31. The optical signal represented by the solid arrows passes through repeating unit 11 and is sent to optical coupler 21. Optical coupler 21 bifurcates the optical signal. One of the optical signals is sent to OLT 201. The other of the optical signals is returned to repeating unit 11. Repeating unit 11 uses the optical signal returned from optical coupler 21 to output a signal representing the result of the repeating process by repeating unit 11. As in the case of a downstream signal, repeating unit 11 outputs, to failure determination unit 14, a signal representing the level of input optical signal, a signal related to synchronization (frequency shift) between a reference clock and a regeneration clock, and a signal representing the result of FEC decoding.

The optical signal represented by the dashed arrows passes through switch 35 and is sent to repeating unit 12. The optical signal further passes through repeating unit 12 and is transmitted to failure determination unit 14 through switch 25. Failure determination unit 14 determines the presence or absence of failure in selected repeating unit 11 based on the signal from the repeating unit 11 and based on the optical signal that has passed through repeating unit 12 and has been input to failure determination unit 14.

According to the fifth embodiment, the failure determination can be performed for each of a plurality of active-system repeating units, as in the second embodiment and the fourth embodiment. Further, the redundancy switching can be performed between a failed repeating unit and a standby-system repeating unit.

### Sixth Embodiment

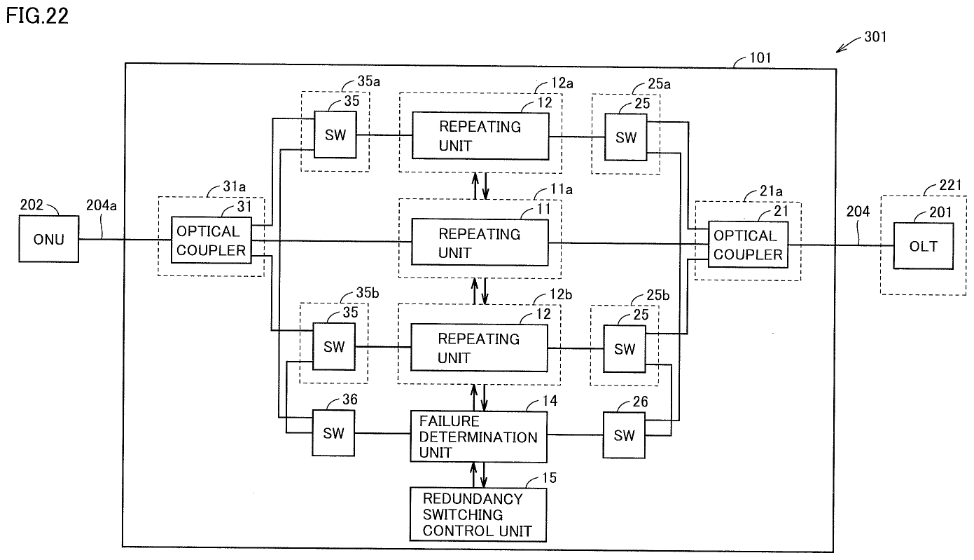

Optical communication system 301 in the sixth embodiment of the present invention is generally the same in configuration as the one shown in FIG. 12. FIG. 22 is a block diagram showing a part of optical communication system 301 in the sixth embodiment of the present invention. With reference to FIG. 13 and FIG. 22, each of optical couplers 21, 31 is replaced by a 1×3 optical coupler in the sixth embodiment. In this respect, the sixth embodiment is different from the third embodiment.

The failure determination in the sixth embodiment is basically the same as the failure determination in the fourth embodiment. Failure determination unit 14 receives, from repeating unit 11, a signal representing the result of the repeating process of optical signal by repeating unit 11. Further, failure determination unit 14 receives two optical signals sent from two respective repeating units 12. Failure determination unit 14 determines the presence or absence of failure in repeating unit 11 based on the two optical signals and the signal from repeating unit 11. If the presence of failure in repeating unit 11 is determined, redundancy switching control unit 15 executes the redundancy switching between repeater package 11a and one of repeater packages 12a, 12b. Note that each of two repeating units 12 may send failure determination unit 14 a signal representing the result of the repeating process of optical signal. As in the fourth embodiment, failure determination unit 14 may determine the presence or absence of failure in selected repeating unit 11 based on the signal from the repeating unit 11 and based on the two signals sent from two respective repeating units 12 to failure determination unit 14.

As described above, according to the sixth embodiment, one active-system repeating unit is combined with a plurality of standby-system repeating units. The presence or absence of failure in the active-system repeating unit is determined by comparison of signals that have passed through the respective repeating units.

### Seventh Embodiment

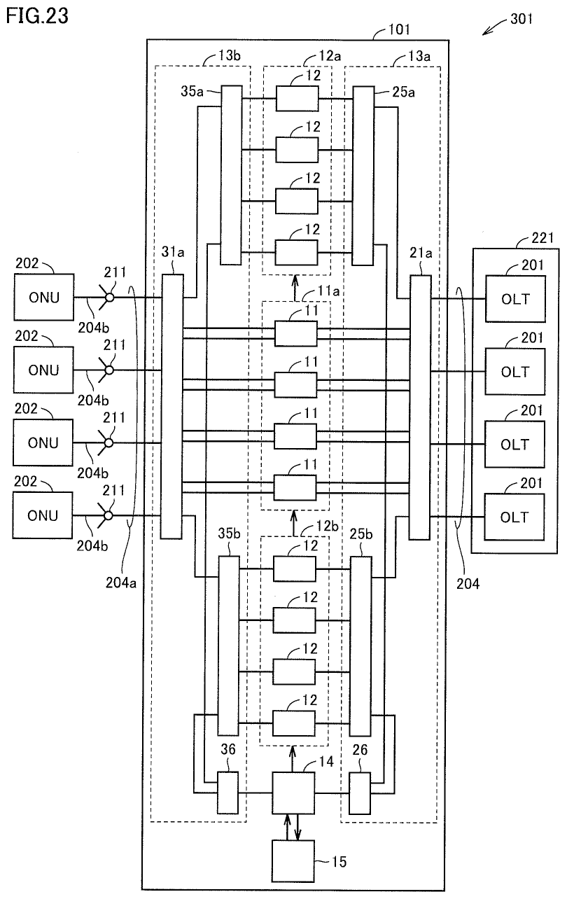

FIG. 23 is a block diagram showing optical communication system 301 and optical signal repeater 101 in a seventh embodiment of the present invention. In the seventh embodiment, optical signal repeater 101 has a path of optical signal between optical coupler unit 21a and repeater package 11a (repeating unit 11), instead of a path of optical signal between optical coupler unit 21a and switch 26. Similarly, optical signal repeater 101 has a path of optical signal between optical coupler unit 31a and repeater package 11a, instead of a path of optical signal between optical coupler unit 31a and switch 26. The other part shown in FIG. 23 is the same in configuration as the corresponding part shown in FIG. 12.

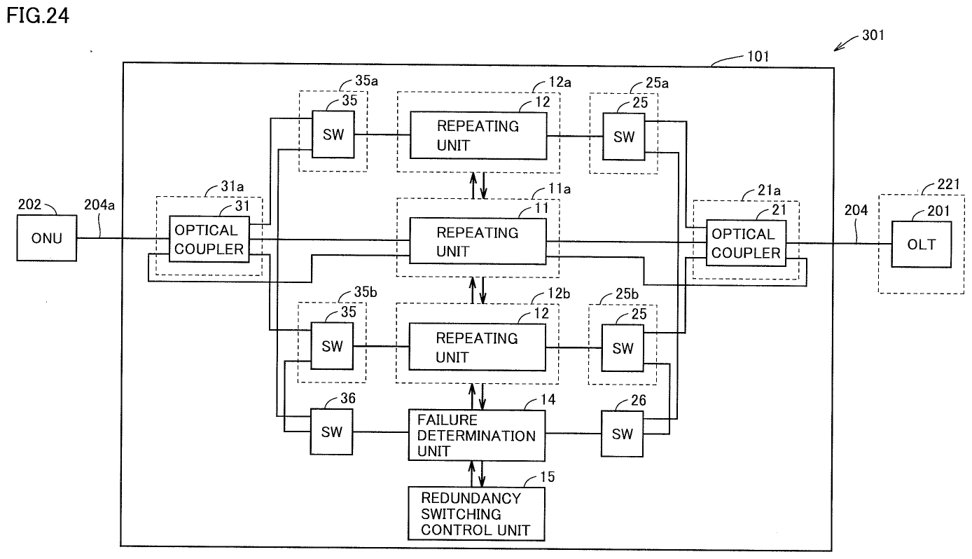

FIG. 24 is a block diagram showing a part of optical communication system 301 in the seventh embodiment of the present invention. FIG. 24 being compared with FIG. 13, optical signal repeater 101 in the seventh embodiment is different from optical signal repeater 101 in the third embodiment in that the former has a path of optical signal between optical coupler 21 and repeating unit 11 and has a path of optical signal between optical coupler 31 and repeating unit 11.

As in the fifth embodiment, optical signal repeater 101 determines the presence or absence of failure in selected repeating unit 11 based on the signal from the repeating unit 11 and based on the optical signal that has passed through repeating unit 12 and has been input to failure determination unit 14.

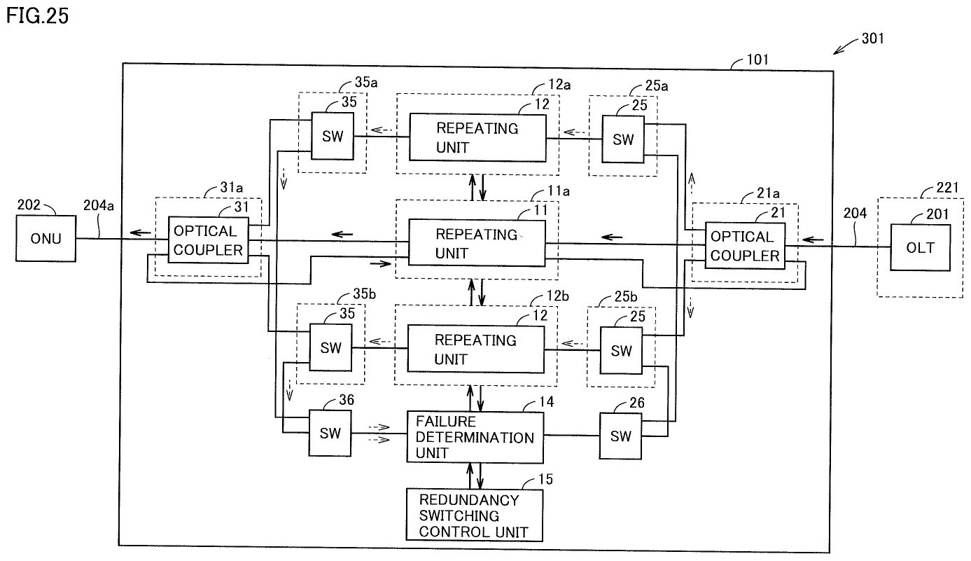

FIG. 25 is a diagram for illustrating the determination of the presence or absence of failure in a repeating unit with the use of a downstream signal by an optical signal repeater in the seventh embodiment of the present invention. As shown in FIG. 25, a downstream signal from OLT 201 is branched into three optical signals by optical coupler 21. The optical signal represented by the solid arrows passes through repeating unit 11 and is sent to optical coupler 31. Optical coupler 31 bifurcates the optical signal. One of the optical signals is sent to ONU 202. The other of the optical signals is returned to repeating unit 11.

The two optical signals represented by the dashed arrows pass through switches 25 and are sent to repeating units 12. The optical signals further pass through repeating units 12 and are transmitted to failure determination unit 14 through switches 35, 36. Failure determination unit 14 determines the presence or absence of failure in selected repeating unit 11 based on the signal from the repeating unit 11 and based on the two optical signals that have passed through two respective repeating units 12 and have input to failure determination unit 14.

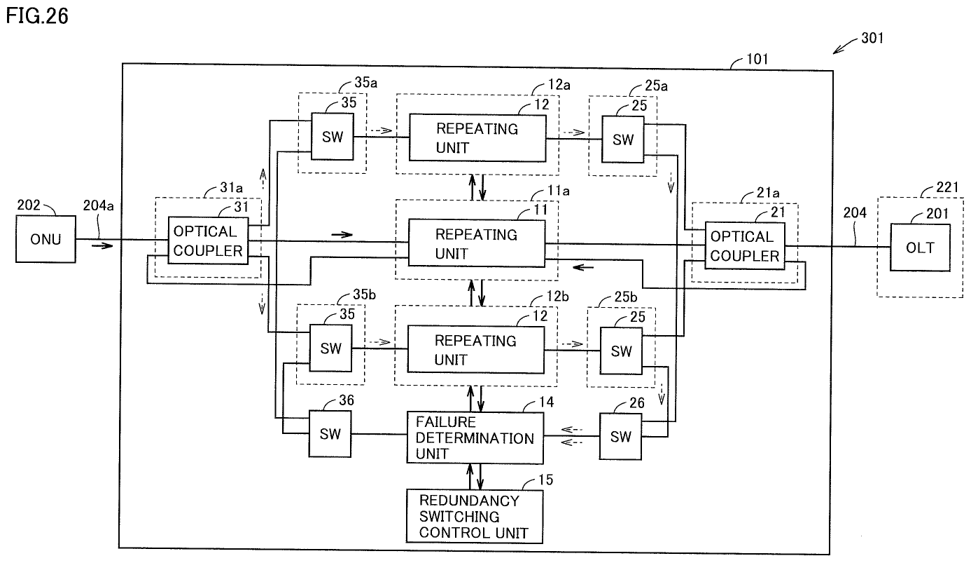

FIG. 26 is a diagram for illustrating the determination of the presence or absence of failure in a repeating unit with the use of an upstream signal by an optical signal repeater in the seventh embodiment of the present invention. As shown in FIG. 26, a downstream signal from OLT 201 is branched into three optical signals by optical coupler 31.

The optical signal represented by the solid arrows passes through repeating unit 11 and is sent to optical coupler 21. Optical coupler 21 bifurcates the optical signal. One of the optical signals is sent to OLT 201. The other of the optical signals is returned to repeating unit 11.

The two optical signals represented by the dashed arrows pass through switches 35 and are sent to repeating units 12. The optical signals further pass through repeating units 12 and are transmitted to failure determination unit 14 through switches 25, 26. Failure determination unit 14 determines the presence or absence of failure in selected repeating unit 11 based on the signal from the repeating unit 11 and based on the two optical signals that have passed through two respective repeating units 12 and have input to failure determination unit 14. However, as in the sixth embodiment, each of two repeating units 12 may send failure determination unit 14 a signal representing the result of the repeating process of optical signal, and failure determination unit 14 may determine the presence or absence of failure in selected repeating unit 11 based on the signal from the repeating unit 11 and based on the two signals that are sent from two respective repeating units 12 to failure determination unit 14.

According to the seventh embodiment, one active-system repeating unit is combined with a plurality of standby-system repeating units. The presence or absence of failure in the active-system repeating unit is determined by comparison among the signals that have passed through the respective repeating units. According to the seventh embodiment, the redundancy switching can be performed between a failed repeating unit and a standby-system repeating unit.

(Additional Notes) (1) An optical signal repeater in an embodiment of the present invention includes: an active-system repeating unit configured to repeat an optical signal; a standby-system repeating unit configured to be interchangeable with the active-system repeating unit; and a redundancy switching control unit configured to, when the active-system repeating unit is in failure, execute redundancy switching between the active-system repeating unit and the standby-system repeating unit.

(2) An optical signal repeater in an embodiment of the present invention includes: at least one first repeating unit configured to repeat an optical signal; at least one second repeating unit configured to be interchangeable with the first repeating unit; a branch portion configured to branch an optical signal and provide the branched optical signal to each of the first repeating unit and the second repeating unit; a failure determination unit configured to compare an optical signal from the first repeating unit with an optical signal from the second repeating unit, and determine the presence or absence of failure in the first repeating unit; and a redundancy switching control unit configured to, if the failure determination unit determines the presence of failure in the first repeating unit, execute redundancy switching between the first repeating unit and the second repeating unit.

(3) An optical signal repeater in an embodiment of the present invention includes: a first group including a plurality of active-system repeating units each of which is configured to repeat an optical signal; a second group including a plurality of standby-system repeating units configured to be interchangeable with the plurality of respective active-system repeating units; a branch portion configured to branch an input optical signal and provide the branched optical signal to each of the first group and the second group; a failure determination unit configured to compare an optical signal from the first group with an optical signal from the second group, and determine the presence or absence of failure in at least one repeating unit of the plurality of active-system repeating units; and a redundancy switching control unit configured to, if the at least one repeating unit is in failure, execute redundancy switching between the first group and the second group.

(4) An optical signal repeater in an embodiment of the present invention includes: an active-system repeating unit configured to repeat an optical signal and output a result of execution of a repeating process of the optical signal; a standby-system repeating unit configured to be interchangeable with the active-system repeating unit; a branch portion configured to branch an input optical signal and provide the branched optical signal to each of the active-system repeating unit and the standby-system repeating unit, a failure determination unit configured to determine the presence or absence of failure in the active-system repeating unit based on the result of execution of the repeating process from the active-system repeating unit and based on an optical signal output from the standby-system repeating unit; and a redundancy switching control unit configured to, if the failure determination unit determines the presence of failure in the active-system repeating unit, execute redundancy switching between the active-system repeating unit and the standby-system repeating unit.

(5) An optical signal repeater in an embodiment of the present invention includes: an active-system repeating unit configured to repeat an optical signal and output a result of execution of a repeating process of the optical signal; a standby-system repeating unit configured to be interchangeable with the active-system repeating unit; a branch portion configured to branch an input optical signal and provide the branched optical signal to each of the active-system repeating unit and the standby-system repeating unit; a failure determination unit configured to determine the presence or absence of failure in the active-system repeating unit based on the result of execution of the repeating process from the active-system repeating unit and based on the result of execution of the repeating process from the standby-system repeating unit; and a redundancy switching control unit configured to, if the failure determination unit determines the presence of failure in the active-system repeating unit, execute redundancy switching between the active-system repeating unit and the standby-system repeating unit.

The embodiments disclosed herein should be construed as being by way of illustration in every respect and not by way of limitation. The scope of the present invention is defined not by the above-described embodiments but by the claims. It is intended that the scope of the present invention encompasses any modification within the scope and meaning equivalent to the scope of the claims.

### REFERENCE SIGNS LIST

11, 12: repeating unit; 11a, 12a, 12b: repeater package; 13a, 13b: branch portion; 14: failure determination unit; 15: redundancy switching control unit; 21, 31, 211: optical coupler; 21a, 31a: optical coupler unit; 25, 26, 35, 36: switch; 25a, 25b, 35a, 35b: switch unit; 41, 42: optical transceiver; 43: signal regenerating unit; 44, 49: WDM unit; 45, 51, 61: receiving unit; 46: BM transmitting unit; 47: transmitting unit; 48: BM receiving unit; 52, 62: clock/data regenerating unit; 53, 63: synchronizing unit; 54, 64: FEC decoding unit; 55: downstream failure determination unit; 65: upstream failure determination unit; 101: optical signal repeater; 201: OLT; 202: ONU; 204: trunk optical fiber; 204a: access optical fiber; 204b: leaf optical fiber; 221: OLT package; 301: optical communication system; S1, S2, S3, S4, S5, S6, S7: step

1. An optical signal repeater comprising:
at least one first repeating unit configured to repeat an optical signal;
at least one second repeating unit configured to be interchangeable with the first repeating unit;
a branch portion configured to branch an optical signal and provide the branched optical signal to each of the first repeating unit and the second repeating unit;
a failure determination unit configured to compare a signal output from the first repeating unit with a signal output from the second repeating unit, and determine presence or absence of failure in the first repeating unit; and
a redundancy switching control unit configured to, if the failure determination unit determines the presence of failure in the first repeating unit, execute redundancy switching between the first repeating unit and the second repeating unit.

2. The optical signal repeater according to claim 1, wherein
the branch portion is configured to branch an optical signal from the first repeating unit and generate a branch signal, and
the failure determination unit is configured to use the branch signal to determine the presence or absence of failure in the first repeating unit.

3. The optical signal repeater according to claim 1, wherein
the number of the first repeating units is larger than the number of the second repeating units, and
the failure determination unit is configured to select a pair of the first repeating unit and the second repeating unit in order to compare the optical signals, and determine the presence or absence of failure in the first repeating unit that constitutes the pair.

4. The optical signal repeater according to claim 1, wherein
the failure determination unit is configured to select a combination of the first repeating unit and the second repeating unit in order to compare the optical signals, and determine the presence or absence of failure in the first repeating unit that constitutes the combination,
the number of the first repeating units included in the combination is one, and
the number of the second repeating units included in the combination is more than one.

5. The optical signal repeater according to claim 1, wherein
each of the first repeating unit and the second repeating unit is configured to execute 3R regeneration on the optical signal and output a digital signal, and
the failure determination unit is configured to determine the presence or absence of failure in the first repeating unit based on the digital signal from each of the first repeating unit and the second repeating unit.

6. A failure determination method for an optical signal repeater configured to repeat an optical signal, the optical signal repeater including a first repeating unit, a second repeating unit configured to be interchangeable with the first repeating unit, and a failure determination unit, the method comprising:
branching an optical signal and providing the branched optical signal to each of the first repeating unit and the second repeating unit;
comparing, using the failure determination unit, a first signal output from the first repeating unit with a second signal output from the second repeating unit; and
determining, using the failure determination unit, presence or absence of failure in the first repeating unit based on a result of the comparing of the first signal with the second signal.
